(19) United States
(12) Patent Application Publication
(10) Pub. No.: US 2026/0152368 A1
(43) Pub. Date: Jun. 4, 2026

(54) MULTI-CONFIGURATION HARNESS SYSTEM

(71) Applicant: YG Solutions LLC, Las Vegas, NV (US)

(72) Inventor: Michael Young, Las Vegas, NV (US)

(21) Appl. No.: 19/407,420

(22) Filed: Dec. 3, 2025

Related U.S. Application Data
(60) Provisional application No. 63/727,267, filed on Dec. 3, 2024.

(51) Int. Cl. B66C 1/14

(52) U.S. Cl. CPC B66C 1/14

(57) ABSTRACT

Disclosed herein is a load rigging harness system for a payload. The system includes a webbing harness surrounding the payload. The load rigging system includes a lateral belt coupled to the webbing harness extending at least partially around the payload, and a plurality of straps having bottom ends attached to the webbing harness and the top ends connected together at a common point. Also disclosed herein is a load rigging harness system for an auxiliary payload. The load rigging harness system comprises an end panel, a plurality of strap loops, each of the strap loops extending from the end panel toward a distal point and configured to wrap at least partially around the auxiliary payload. A connector and mating fasteners are arranged at the distal points for securing the strap loops together around the auxiliary payload.

### RELATED APPLICATIONS

This application claims priority to U.S. Provisional Patent Application No. 63/727,267, filed Dec. 3, 2024, and incorporates the same herein by reference.

### TECHNICAL FIELD

This invention relates to load rigging harness systems that can be configured in multiple ways to accommodate varied uses and varied load shapes.

### BACKGROUND

Payloads of varying size and type may need to be delivered, especially from the air, under circumstances where the load must be prepared, delivered, and deployed rapidly and/or under adverse conditions. For example, materiel may be bundled or crated and dropped, such as by parachute, to personnel on the ground or in the water. The loads must be securely harnessed and/or rigged for rapid and secure attachment to a delivery means, but then also be removable rapidly and safely for deployment of the load.

For example, a parachute-deployed payload may be an inflatable boat kit that is received and assembled in rough water by rescue personnel. A prior harness for attachment of the parachute required that the harness be cut off the payload using knives. This task is particularly challenging while swimming in rough waves and risks mission-jeopardizing damage to the boat.

Other materiel payloads dropped to land may vary greatly in size and shape and need a harness system that maintains its other benefits while being adjustable to accommodate the payloads'sizes and shapes.

In view of these and other challenges, a need has developed for improved rigging harness systems and harness systems.

### SUMMARY OF THE INVENTION

The present invention provides multi-configurable load harness rigging systems that can accommodate varied load shapes and varied uses while providing novel features and functions. It provides rapid deployment (attachment to a load and to a delivery means, such as a line or parachute) and rapid removal where and when the load is received.

It is designed to be easily and quickly assembled, for example, on an aircraft over the objective area, allowing for rapid deployment of critical supplies and equipment. This can be especially important in emergency situations where time is of the essence. It can be quickly and easily disassembled upon landing, allowing for quick evacuation of the delivery aircraft and minimizing the risk of detection or attack. This is particularly useful in tactical situations where stealth and rapid response are critical.

According to one or more embodiments, a load rigging harness system for a payload includes a webbing harness surrounding the payload. The webbing harness includes a first end and a second end that is opposite the first end, wherein the webbing harness is secured together at the first end and detachably secured together at the second end. The load rigging harness system includes a lateral belt coupled to the webbing harness and extending at least partially around the payload. Further, the load rigging harness system includes a plurality of straps each having a bottom end and a top end, each of the bottom ends attached to the webbing harness and the top ends are connected together at a common point.

Another embodiment can provide an adjustable-length, multi-purpose Military Tandem Tether Bundle (MTTB), such as for use by paratroopers.

According to one or more embodiments, a load rigging harness system for an auxiliary payload includes an end panel on which the auxiliary payload may be arranged. The load rigging harness system includes a plurality of strap loops, each of the strap loops extending from the end panel toward a distal point, wherein the strap loops are adjustable in length and configured to wrap at least partially around the auxiliary payload. The load rigging harness system includes a connector, wherein the plurality of strap loops includes a first strap loop and one or more remaining strap loops, and the connector is arranged at the distal point of the first strap loop. Further, The load rigging harness system includes a mating fastener arranged at the distal points of the one or more remaining strap loops, wherein the mating fasteners are configured to connect to the connector, and thereby secure the strap loops together at least partially around the auxiliary payload.

Other aspects, features, benefits, and advantages of the present invention will become apparent to a person of skill in the art from the detailed description of various embodiments with reference to the accompanying drawing figures, all of which comprise part of the disclosure.

### BRIEF DESCRIPTION OF THE DRAWINGS

Like reference numerals are used to indicate like parts throughout the various drawing figures, wherein:

FIG. 1 is pictorial view of an inflatable barrel payload secured on a double end cap RAM-T module with a harness system rigged for single point attachment to a parachute or line deployment system according to one embodiment of the present invention;

FIG. 2 is a similar showing a different style of inflatable barrel secured to a single cap RAM-T module with a harness system according to another embodiment of the present invention;

FIG. 3 is a pictorial view of a ridged shape payload secured with a harness system according to yet another embodiment of the present invention;

FIG. 4 is a first isometric view of a single cap RAM-T module without a payload;

FIG. 5 is a second isometric view thereof;

FIG. 6 is an isometric view of an inflatable barrel payload secured on a RAM-T module with a harness system according to one embodiment of the present invention positioned for sliding movement on a surface;

FIG. 7 is a schematic plan view of an alternate harness system according to another embodiment of the present invention;

FIG. 8 is a pictorial view thereof; and

FIG. 9 is a pictorial view of the harness system on a payload, such as for paratrooper carry.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments. “Up” or “above” refers to the vertical upward direction of the embodiment as pictured in a particular figure. “Down” or “below” refers to the opposite direction.

The present invention provides embodiments of an adaptable, modular harness system for varied load shapes and varied uses. Slide fittings allow a large degree of adjustment to webbing/strap lengths to accommodate loads of all sizes. Quick-release connectors allow the harness and rigging system to be removed easily without cutting. It can include a continuous shock mitigation strapping system that absorbs and dissipates shock during delivery. It provides an agnostic connection to any parachute system, including self-guided systems, providing greater flexibility in delivery options.

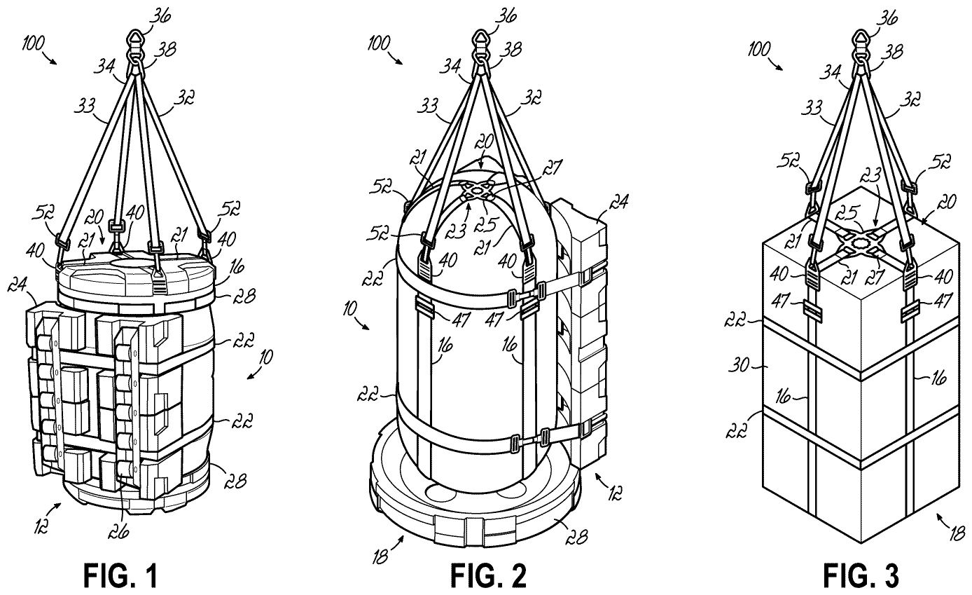

Referring first to FIGS. 1-3, a system 100 is depicted, according to one or more embodiments, that can be used to secure a payload in an adjustable attachment harness and to provide attachment points, such as for a four-point spider or pyramid rig.

As shown in FIGS. 1 and 2, the system 100 can be used with a payload 10 on a handling pallet 12, such as the Rigged Alternate Method Tandem (RAM-T) adaptable modular aerial delivery system by Onyx Industries LLC of McLean, Virginia. The invention can be used with inflatable barrel container 14, with or without a RAM-T pallet 12. Inflatable barrel containers 14 provide cushioning and buoyancy to the payload 10, providing additional protection in water landing scenarios. This can be particularly valuable in emergency situations where water landing may be necessary.

In the illustrated embodiment, the system 100 includes a webbing harness 16 surrounding the inflatable barrel container 14. The webbing harness 16 has a first end 18 and a second, opposite end 20, wherein the webbing harness 16 is secured together at the first end 18 and detachably secured together at the second, opposite end 20, such that the inflatable barrel container 14 may be inserted into the webbing harness 16 and removed therefrom via the second end 20. In the illustrated example, the second end 20 comprises four belt/band ends 21 that may be attached together into a closed configuration via a closure mechanism 23 23. In some embodiments, the closure mechanism 23 comprises mating connectors 25, 27, such as a four point connector (i.e., a ninja star) 25 and snaps 27 (e.g., a B-12 type snap or a quick ejector snap). Here, one of the snaps 27 is arranged on each of the belt/band ends 21 and may be selectively secured to the four point connector 25. In other embodiments, the mating connectors 23 includes quick ejector snaps on a first pair of the belt/band ends 21 and a mating adjustable snap (e.g., a B-12 Type snap) on a second opposite pair of the belt/band ends 21 that is to be secured relative to the first pair of the belt/band ends 21.

The system 100 can include lateral belts 22 that pass through slots or keeper loops (not shown) on individual bands/straps of the main harness 16, and the lateral belts 22 can secure the harness 16 and payload 10 to the pallet 12 or other delivery structure.

Connection points 40 may be arranged on the main harness 16 to provide a lifting or rigging points, for example, to which another lifting harness may be connected to the main harness 16 in order to lift the system 100. The connection points 40 is a connector, such as well-known two-slot or 4-slot adjustable connectors, that is provided on the main harness 16 and may include a ring or loop that defines the lifting or rigging attachment points. Each of the connection points 40 is provided on one of the discrete vertical straps/bands/belts of the harness 16 and, in some embodiments, each of the connection points 40 is fixed (e.g., sewn) onto one of the discrete vertical straps/bands/belts of the harness 16. For example, the discrete vertical strap/band/belt of the harness 16 may include a loose flap or end that extends through a slot in the connection point 40, and then the loose flap or end is sewn onto the main body portion of the discrete vertical strap/band/belt to define a closed loop and thereby secure the connection point 40 to the main harness 16. In some embodiments, the connection point 40 includes an integrated friction adapter that is operable to allow for loosening or tightening of the vertical strap/band/belt of the harness 16 on which the connection point 40 is arranged; however, in the illustrated embodiment, each of the connection points 40 is a parachute V-ring that is secured on its respective vertical strap/band/belt of the harness 16, and each of the V-rings is associated with an individual and separate friction adapter 47 positioned beneath (i.e., towards the first end 18) the V-ring to allow for tightening or loosening of the vertical strap/band/belt of the harness 16 on which the particular connection point 40 is arranged.

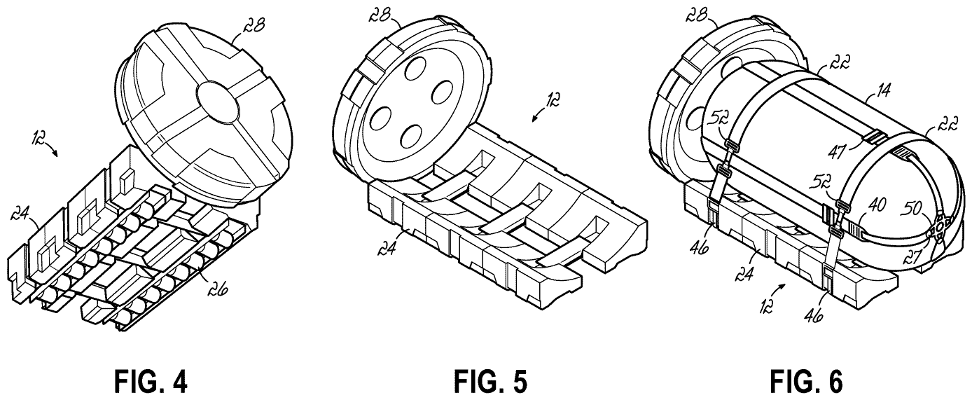

Structural detail of the RAM-T pallet 12 is shown in FIGS. 4 and 5. It can include a base 24 with rollers 26 or wheels and one or more rigid end caps 28 attached to the base 24. Thus, the pallet 12 may include the base 24, one of more end caps 28 rigidly attached to the base 24, and wheels or rollers 26 arranged on the base 24. An example of the present harness system 100 attachment to an inflatable barrel 14 and RAM-T pallet 12 is shown in FIGS. 1, 2, and 6.

As shown in FIG. 3, an unpalletized (bare) payload 30 can be in a container with a regular shape, although the payload 30 can be any shape and it can likewise be used for an irregular, uncontainerized item, pack, or bundle of items. The harness 16 has a first, closed end 18 and a second, closable end 20. The closed end 18 may be a single point, like an “X” (FIGS. 2 and 3) where the webbing harness 16 and the straps 22 are secured together substantially at a right angle. The straps 22 are coupled to the harness 16, for example, the straps 22 may extend through slots or loops in the harness 16 to permit relative movement there-between, as detailed above, or the straps 22 may be rigidly or physically connected to portions of the harness 16 to inhibit such relative motion. Regardless, in this embodiment, the straps 22 are coupled to the harness 16 and arranged at least partially around the payload 30. The first and second closed and closable ends 18, 20 can be oriented at either a “top” or “bottom” end of the payload 30, which may be arbitrarily designated. The X-shaped style harness 16 also can be used as a spider or pyramid rig 32, connected at a single, common point 34 to a swivel 36, for example, via a carabiner 38, in the nature of an adjustable-length Military Tandem Tether Bundle (MTTB), which adapts multiple attachment points to a single connection point for suspension by a parachute or line to a parachutist. In the illustrated embodiment, the spider or pyramid rig 36 comprises a plurality of straps 33 that each has a bottom (or first) end at which each is connected to the harness 16 and a top (or second) end, wherein the top ends are attached together at the common point 34. Thus, the straps of the pyramid rig 36 extend from the closable end 20 to the common point 34, where each of the plurality of straps of the pyramid rig 36 are joined together, and the carabiner 38 connects the common point 34 to the swivel 36. In an embodiment, a quick release snap fastener 52 is arranged at the bottom end of each of the straps 33 for attachment to the connection points 40 arranged on the harness 16.

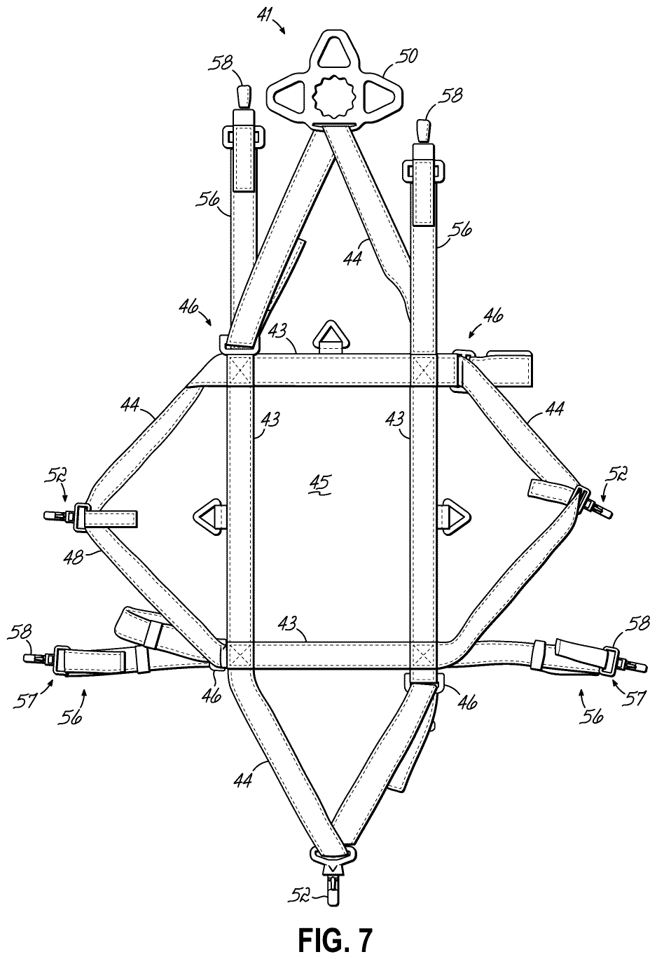

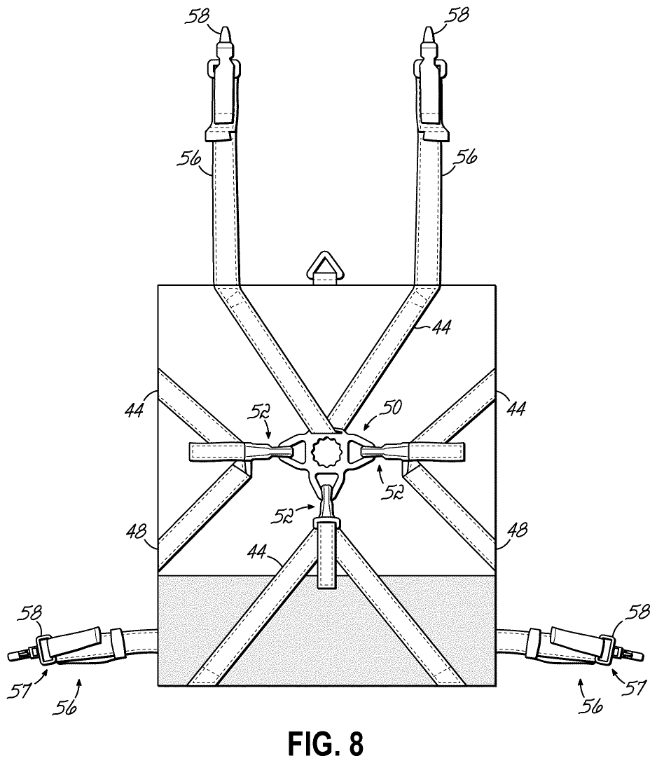

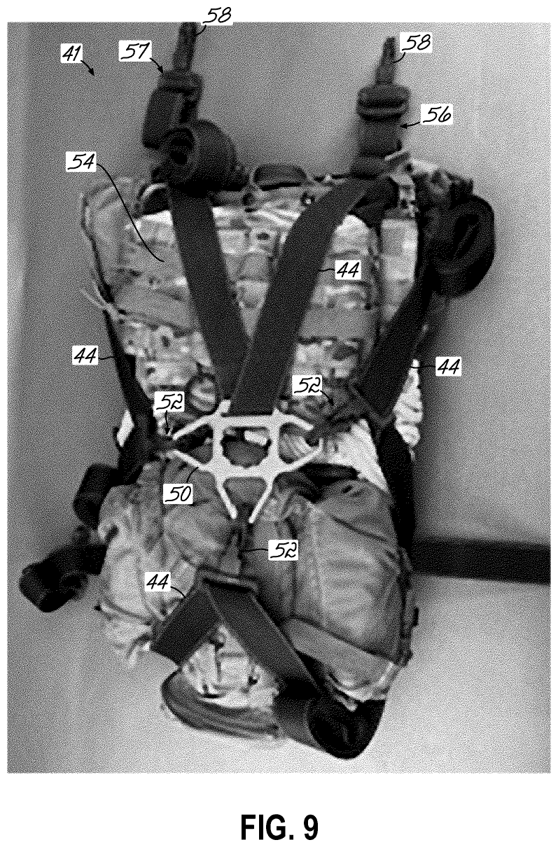

FIGS. 7-9 depict an embodiment of a system 41 that is operable to attach auxiliary or personnel payloads/equipment (e.g., rucksacks), according to one or more embodiments. The system 41 has an “end panel” 42 that can be open (as shown) or could also be a solid panel of flexible material, such as fabric. The end panel 42 can be a square (as shown) or can be any suitable multi-sided or round shape. In embodiments where the end panel 42 is “open”, the end panel 42 may be defined by individual straps or belts 43 and an opening 45 is defined in between the straps or belts 43. In some embodiments, the end panel 42 is a piece of substantially closed piece of fabric (i.e., without the central opening 45) placed on top of the individual straps or belts 43.

The system 41 includes a plurality of strap loops 44 that each extend from the end panel 42 to a distal point 48. In the illustrated embodiment, each of the strap loops 44 includes a first end 61, a second end 63, and an intermediate length 65 extending between the ends 61, 63. Here, the first and second ends 61, 63 are attached to the end panel 42 such that the intermediate length 65 extends outward from the end panel 42 as a loop of material on which the distal point 48 is defined. The strap loops 44 may be adjustable in length, for example, via an adjustment slider 46 operable to allow the user to pull a length of the strap loop 44 through a portion of the adjustment slider 46 to thereby shorten the remaining length of the strap loop 44. At the distal point 48 of each of the strap loops 44, which may vary depending on length adjustment, each of the strap loops 44 has a connector 50 or a mating fastener 52. The connector 50 may be, for example, a multi-point or four-point connector 50 (sometimes referred to as a “Ninja Star”) and the fastener 52 may be a quick release snap fastener 52 (such as with a tensile strength of 2,500 pounds) that can be attached together to form to close the harness over a payload 54. In the illustrated embodiment where the system 41 includes four (4) separate strap loops 44, the connector 50 is arranged on the distal end 48 of just one of the strap loops 44, and the fasteners 52 are arranged on the distal ends 48 of the remaining three (3) strap loops 44. Thus, the connector 50 may be arranged on one of the strap loops 44 and the mating fasteners 52 may be arranged on the remaining ones of the strap loops 44. To secure the payload 54 within the system 41, a bottom side of the payload 54 may be placed on the end panel 42, the plurality of strap loops 44 may be wrapped or extended at least partially over and around the payload 54 such that the connector 50 and mating fasteners 52 are on a top side of the payload 54, and then the mating fasteners 52 may be connected to the connector 50, such that the strap loops 44 are locked in place (relative to each other) over and around the payload 54, thereby securing the payload 54 in place within the system 41. If needed, the length of the strap loops 44 may be adjusted to tighten them onto the payload 54 and thereby further secure the payload 54 within the system 41.

The system 41 may also include one or more auxiliary straps 56 utilizable to secure an auxiliary payload or personnel equipment (e.g., a rucksack) to the system 41. The auxiliary straps 56 can extend from the strap loops 44, for example, from portions of the strap loops 44 in between the end panel 42 and the distal ends 48, and/or the auxiliary straps 56 can separately extend from corners or other points on the end panel 42. These auxiliary straps 56 can have free ends 57 with quick release snap fasteners 58 attached to the free ends 57. The auxiliary straps 56 can be adjustable in length, for example, by using release snap fasteners 58 that can include a friction adjustment slide. These can provide auxiliary payload securement, such as to a parachute harness (not shown). Excess webbing length cab be coiled for stowage.

In either embodiment, the harness is adjustable in size by adjustment of webbing straps, such as with common adjustment slides 46. The webbing can be, for example, 1.7 inch wide, Type 7 nylon webbing having a tensile strength of, for example, 6000 pounds. Length adjustment can also be accomplished by using quick ejector snaps 52 that can include a friction adjustment slide.

Either embodiment of the harness can be quickly and easily removed or released from the payload 10, 30, 54, even in adverse conditions. Prior designs required cutting, which put the payload at risk of damage.

While one or more embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention, defined by the following claim or claims.

What is claimed is:

1. A load rigging harness system for a payload, comprising:
a webbing harness substantially surrounding the payload and having a first end and a second end that is opposite the first end, wherein the webbing harness is secured together at the first end and detachably secured together at the second end;
a lateral belt coupled to the webbing harness extending at least partially around the payload; and
a plurality of straps each having a bottom end and a top end, each of the bottom ends attached to the webbing harness and the top ends are connected together at a common point.

2. The system of claim 1, further comprising adjustable friction connection points arranged on the webbing harness.

3. The system of claim 2, wherein the adjustable friction connection are two slot adjustable friction connections and/or four slot adjustable friction connections.

4. The system of claim 2, wherein the bottom ends of the plurality of straps includes a quick release snap fastener for attachment to the connection points arranged on the webbing harness.

5. The system of claim 1, wherein the webbing harness includes slots or loops through which the lateral belt extends.

6. The system of claim 1, further comprising a swivel arranged proximate to the common point.

7. The system of claim 6, further comprising a carabiner that connects the swivel and the common point together.

8. The system of claim 1, wherein the payload is arranged on a delivery structure, and the lateral belt secures the webbing harness and the payload to the delivery structure.

9. The system of claim 8, wherein the payload is an inflatable barrel container and the delivery structure is a pallet.

10. The system of claim 9, wherein the inflatable barrel container and the pallet are part of a rigged alternate method tandem adaptable module aerial delivery system.

11. The system of claim 9, wherein the pallet includes a base, an endcap attached to the base, and wheels or rollers arranged on the base.

12. A load rigging harness system for an auxiliary payload, comprising:
an end panel relative to which the auxiliary payload may be arranged;
a plurality of strap loops, each of the strap loops extending from the end panel toward a distal point, wherein the strap loops are adjustable in length and configured to wrap at least partially around the auxiliary payload;
a connector, wherein the plurality of strap loops includes a first strap loop and one or more remaining strap loops, and the connector is arranged at the distal point of the first strap loop; and
a mating fastener arranged at the distal points of the one or more remaining strap loops, wherein the mating fasteners are configured to connect to the connector, and thereby secure the strap loops together at least partially around the auxiliary payload.

13. The system of claim 12, wherein the end panel includes a plurality of straps which together define an opening.

14. The system of claim 12, wherein the end panel includes solid piece of fabric.

15. The system of claim 12, further including an adjustable slider connected to at least one of the strap loops for adjusting the length of the strap loop.

16. The system of claim 12, wherein the payload is a parachute.

17. The system of claim 12, wherein the connector is a four-point connector, and the one or more remaining strap loops comprises three strap loops that each have one of the mating fasteners arranged at the distal point thereof.
